(19) United States
(12) Patent Application Publication
(10) Pub. No.: US 2024/0109020 A1
(43) Pub. Date: Apr. 4, 2024

(54) GAS PURIFICATION APPARATUS

(71) Applicant: L'Air Liquide, Société Anonyme pour i'Exploitation des Procédés Georges Claude, Paris (FR)

(72) Inventors: Kenji HIROSE, Kakogawa (JP); Shusei MIO, Kobe (JP); Shinji TOMITA, Hyogo (JP)

(21) Appl. No.: 18/376,192

(22) Filed: Oct. 3, 2023

(30) Foreign Application Priority Data
Oct. 4, 2022 (JP) 2022-160118

(51) Int. Cl. B01D 53/04

(52) U.S. Cl. CPC B01D 53/0438; B01D 53/0446; B01D 2253/102; B01D 2253/104; B01D 2253/108

(57) ABSTRACT

A gas purification apparatus includes: an impurity removal unit for removing impurities in a feed gas; a purification vessel accommodating the impurity removal unit; and a heating unit which is provided inside the purification vessel in a state of non-contact with the impurity removal unit, and heats the purification vessel from the inside, the heating unit being detachably mounted in the purification vessel.

### CROSS REFERENCE TO RELATED APPLICATIONS

This application claims the benefit of priority under 35 U.S.C. § 119 (a) and (b) to Japanese Patent Application No. 2022-160118, filed Oct. 4, 2022, the entire contents of which are incorporated herein by reference.

### BACKGROUND

### Technical Field

The present disclosure relates to a gas purification apparatus for purifying a high-purity purified gas from a feed gas.

### Prior Art

Recent years have seen demand for gas purification apparatuses which are designed to make gases used for semiconductor production, etc. highly pure (e.g., 1 ppb or less of impurities). A packing material comprising a getter material, a catalyst and/or an adsorbent, etc., either singly or in combination, is used in order to purify the high-purity gas (Patent Documents 1-4). The packing material may be heated for use, and Patent Document 5 describes a gas purification apparatus in which a heating unit is provided outside a gas purification vessel. There are also gas purification apparatuses in which a heating unit is provided inside the purification vessel.

The heating unit needs to be repaired or replaced if it breaks down. When the heating unit is provided inside the purification vessel, however, it is not a simple matter to open the sealed purification vessel at the installation site and to extract the heating unit from the purification vessel. The purification vessel is therefore moved from the installation site to a different location in order to repair or replace the heating unit, or the purification vessel which accommodates the heating unit, etc. is itself replaced, but costs are involved in both cases.

### PRIOR ART DOCUMENTS

Patent Document 1 JP H05-116914 A
Patent Document 2 JP H06-58663 A
Patent Document 3 U.S. Pat. No. 4,713,224 A
Patent Document 4 US 2014/252266 A1
Patent Document 5 JP H02-120212 A

### SUMMARY OF THE INVENTION

The objective of the present disclosure lies in providing a gas purification apparatus enabling simple repair or replacement of a heating unit provided inside a purification vessel.

A gas purification apparatus according to the present disclosure comprises: an impurity removal unit for removing impurities in a feed gas; a purification vessel accommodating the impurity removal unit; and a heating unit which is provided inside the purification vessel in a state of non-contact with the impurity removal unit, and heats the purification vessel from the inside, the heating unit being detachably mounted in the purification vessel.

By virtue of this configuration, the heating unit provided inside the purification vessel can be easily removed from the purification vessel, and the heating unit can be easily mounted in the purification vessel. This enables simple repair or replacement of the heating unit provided inside the purification vessel.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a view in cross section showing a gas purification apparatus according to a first embodiment.

FIG. 2 is a view in cross section showing a gas purification apparatus according to a second embodiment.

FIG. 3 is a view in cross section showing a gas purification apparatus according to a third embodiment.

FIG. 4 is a view in cross section showing a gas purification apparatus according to a fourth embodiment.

### DETAILED DESCRIPTION OF THE PREFERRED EMBODIMENTS

### First Embodiment

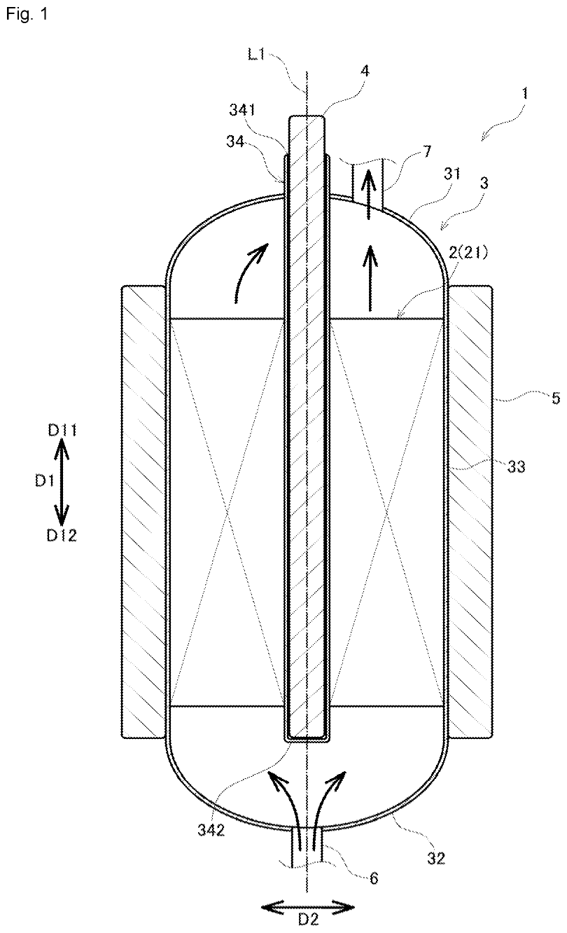

A gas purification apparatus 1 according to a first embodiment will be described with reference to FIG. 1. It should be noted that dimension ratios in the drawings (FIGS. 1-4) do not necessarily match actual dimension ratios, and the dimension ratios among the drawings are not necessarily matching either. FIG. 1 is a view in cross section showing the gas purification apparatus 1 according to the first embodiment.

As shown in FIG. 1, the gas purification apparatus 1 comprises: an impurity removal unit 2 for removing impurities in a feed gas; a purification vessel 3 accommodating the impurity removal unit 2; and a heating unit 4 for heating the purification vessel 3 from the inside (the impurity removal unit 2 from the inside). The gas purification apparatus 1 may comprise a plurality of purification vessels 3, etc. When a plurality of purification vessels 3 are provided, the purification vessels 3 may be connected in parallel or connected in series.

A purified gas which is purified by means of the gas purification apparatus 1 includes at least one of: air, oxygen, nitrogen, argon, carbon dioxide, hydrogen, helium, neon, krypton, and xenon, for example. Impurities are components contained in the feed gas, other than the gas to be purified.

The impurity removal unit 2 is mounted in the purification vessel 3 and/or in an inner cylinder portion 34 which will be described later. The impurity removal unit 2 is provided so as to surround a periphery of the inner cylinder portion 34. In this embodiment, the impurity removal unit 2 is formed with a toric shape, but is not limited to such a shape. The impurity removal unit 2 comprises a packing material 21 including at least one of a catalyst, a getter material and an adsorbent.

The packing material 21 is appropriately set according to the type of impurities to be removed, etc. Examples of catalysts which may be used include: precious metal catalysts (e.g., palladium, etc.), and transition metal catalysts (e.g., nickel, copper or manganese, etc.), among others. Examples of getter materials which may be used include alloys containing at least one metal from among zirconium, vanadium, iron, cobalt, nickel, chromium, titanium, and aluminium, among others. Examples of adsorbents which may be used include: activated carbon, activated alumina, and zeolite (e.g., a molecular sieve, etc.), among others. A temperature of the packing material 21 is appropriately set according to the constitution, etc. of the packing material. The temperature of the packing material 21 is between 80 degrees and 700 degrees, for example.

The purification vessel 3 is formed as a cylindrical vessel. The purification vessel 3 comprises: a first end portion 31, a second end portion 32, and a side portion 33 connecting the first end portion 31 and the second end portion 32. In this embodiment, the first end portion 31 constitutes an upper portion of the purification vessel 3, and the second end portion 32 constitutes a lower portion of the purification vessel 3, but this is not limiting. For example, the first end portion 31 may constitute the lower portion of the purification vessel 3, and the second end portion 32 may constitute an upper portion of the purification vessel 3.

The purification vessel 3 comprises an inner cylinder portion 34 extending along a centre axis L1 direction (axial direction D1) of the purification vessel 3. Within the axial direction D1, a direction running from the second end portion 32 toward the first end portion 31 is referred to as a first axial direction D11, and a direction running from the first end portion 31 toward the second end portion 32 is referred to as a second axial direction D12. The first axial direction D11 denotes upward and the second axial direction D12 denotes downward in this embodiment.

The inner cylinder portion 34 is formed with a cylindrical shape. The inner cylinder portion 34 is preferably formed by a material having a low coefficient of thermal expansion. This makes it possible to limit expansion of the inner cylinder portion 34 due to heat from the heating unit 4, and also to limit an increase in the size of a gap between the inner cylinder portion 34 and the heating unit 4 which is accommodated in (inserted into) the inner cylinder portion 34. Furthermore, the inner cylinder portion 34 is preferably formed by a material having good heat transfer properties. This enables heat from the heating unit 4 to be readily transmitted into the purification vessel 3.

The inner cylinder portion 34 has one end 341 which opens to outside of the purification vessel 3, and another end 342 which is closed by the interior of the purification vessel 3. In this embodiment, the inner cylinder portion 34 is formed with a cylindrical shape and is bonded to the first end portion 31 of the purification vessel 3, but this is not limiting. For example, the inner cylinder portion 34 may be formed with a square cylindrical shape and may be bonded to the second end portion 32 of the purification vessel 3.

Said one end 341 of the inner cylinder portion 34 is preferably provided at a position protruding in the first axial direction D11 from the first end portion 31 of the purification vessel 3. This makes it possible to ensure a margin for bonding the inner cylinder portion 34. Said other end 342 of the inner cylinder portion 34 is preferably provided on the second axial direction D12 side of the impurity removal unit 2. This makes it possible to increase an area of contact between the impurity removal unit 2 and the inner cylinder portion 34, and enables efficient heating of the packing material 21 by the heating unit 4.

A centre axis of the inner cylinder portion 34 is preferably substantially aligned with the centre axis L1 of the purification vessel 3. This enables the heating unit 4 to be provided in the centre of the purification vessel 3, and enables efficient heating of the inside (packing material 21) of the purification vessel 3. There is one inner cylinder portion 34 in this embodiment, but a plurality thereof may be provided.

The heating unit 4 (also referred to as the inside heating unit 4) is provided inside the purification vessel 3 in a state of non-contact with the impurity removal unit 2. An electric heater, a sheath heater, a ceramic heater, or a halogen lamp, etc. may be used as the heating unit 4, for example. There is one heating unit 4 in this embodiment, but a plurality thereof may be provided.

The heating unit 4 is detachably mounted in the purification vessel 3. By virtue of this configuration, the heating unit 4 provided inside the purification vessel 3 can be easily removed from the purification vessel 3, and the heating unit 4 can be easily mounted in the purification vessel 3. This enables simple repair or replacement of the heating unit 4 provided inside the purification vessel 3. As a result, there is no need to replace the purification vessel 3 itself or to move the purification vessel 3 from its installation site, which enables a reduction in the cost of repair or replacement of the heating unit 4.

In this embodiment, the heating unit 4 is bar-shaped, and is detachably accommodated in (inserted into) the inner cylinder portion 34. This allows the heating unit 4 to be mounted in the purification vessel 3 by accommodating the heating unit 4 in the inner cylinder portion 34, and allows the heating unit 4 to be removed from the purification vessel 3 by extracting (withdrawing) the heating unit 4 from the inner cylinder portion 34. Furthermore, leakage of a gas inside the purification vessel 3 can be prevented without providing a cover on the purification vessel 3. The heating unit 4 is preferably inserted as far as said other end 342 of the inner cylinder portion. The gas purification apparatus 1 may be provided with a fixing means for fixing the heating unit 4 in the inner cylinder portion 34.

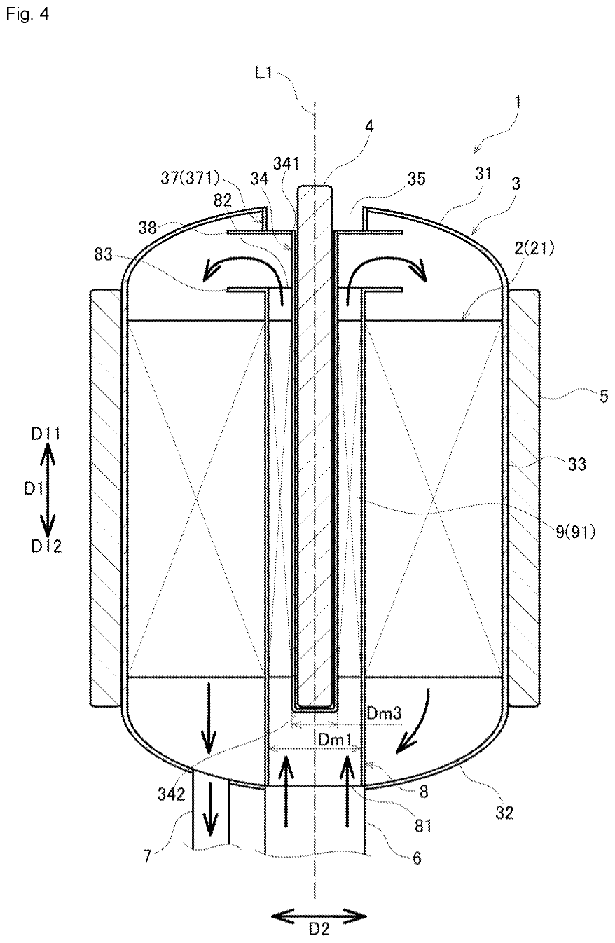

It is preferable for the heating unit 4 not to come into contact with (to be in non-contact with) the impurity removal unit 2 (packing material 21) during attachment to/detachment from the purification vessel 3. This is because there is a risk of a change in a packing state of the packing material 21 and a change in the impurity removal capability thereof if the heating unit 4 comes into contact with the packing material 21 when it is attached/detached. In this embodiment, contact between the heating unit 4 and the packing material 21 during attachment/detachment is prevented by providing the inner cylinder portion 34. The same also applies to an in-pipe packing material 91 (see FIG. 4) which will be described later.

An outer diameter of the heating unit 4 is smaller than an inner diameter of the inner cylinder portion 34. The heating unit 4 may be closely attached to the inner cylinder portion 34. Furthermore, a support for supporting the heating unit 4 may be provided between the heating unit 4 and the inner cylinder portion 34 if there is a large gap between the heating unit 4 and the inner cylinder portion 34.

A length dimension of the heating unit 4 in the axial direction D1 is preferably greater than a length dimension of the inner cylinder portion 34 in the axial direction D1. That is to say, in a state in which the heating unit 4 has been inserted into the inner cylinder portion 34, the heater unit 4 preferably protrudes from the inner cylinder portion 34. This makes it easier to extract the heating unit 4 from the inner cylinder portion 34.

The gas purification apparatus 1 according to this embodiment comprises: at least one of an outside heating unit 5 for heating the purification vessel 3 from the outside, and a heat insulating portion (not depicted) for suppressing heat escape from the purification vessel 3; a supply unit 6 for supplying the feed gas to the purification vessel 3; and a discharge unit 7 for discharging, from the purification vessel 3, a purified gas that has passed through the impurity removal unit 2, but this is not limiting.

The outside heating unit 5 is arranged around the purification vessel 3. In this embodiment, the outside heating unit 5 is a pad or band heater, etc. having an electrical heating wire, and is attached (affixed) to the side portion 33 of the purification vessel 3, but this is not limiting. The outside heating unit 5 may be the same as the heating unit 4, for example.

The heat insulating portion is arranged around the purification vessel 3. The heat insulating portion is attached to the outside of the side portion 33 of the purification vessel 3 or to the outside of the outside heating portion 5. The heat insulating portion comprises a heat insulation material. Examples of heat insulation materials which may be used include heat insulation materials for high-temperature use, such as glass wool or rock wool.

The outside heating unit 5 and/or the heat insulating portion are/is arranged so as to cover the periphery of the purification vessel 3. In this embodiment, the outside heating unit 5 and the heat insulating material are attached to the purification vessel 3 so as to cover the side portion 33 of the purification vessel 3, but are not limited to this configuration. For example, the outside heating unit 5 and/or the heat insulating portion may be attached to the first end portion 31 or the second end portion 32 of the purification vessel 3, or may be arranged at a position away from the purification vessel 3.

The supply unit 6 is attached to the purification vessel 3. In this embodiment, the supply unit 6 is attached to the second end portion 32 of the purification vessel 3, but this is not limiting. For example, the supply unit 6 may be attached to the first end portion 31 or the side portion 33 of the purification vessel 3. The supply unit 6 is arranged in the centre (on the centre axis L1) in a radial direction D2, but is not limited to this arrangement. The radial direction D2 is a direction orthogonal to the centre axis L1 and away from the centre axis L1.

The discharge unit 7 is attached to the purification vessel 3. In this embodiment, the discharge unit 7 is attached to the first end portion 31 of the purification vessel 3, but this is not limiting. For example, the discharge unit 7 may be attached to the second end portion 32 or the side portion 33 of the purification vessel 3. The discharge unit 7 is arranged further outward than the inner cylinder portion 34 in the radial direction D2, but is not limited to this arrangement.

The gas purification apparatus 1 preferably comprises a baffle plate (also known as a baffle board) which is not depicted, the baffle plate being arranged on the inside of the purification vessel 3 upstream of the impurity removal unit 2. This allows a feed gas flow path to be controlled by means of the baffle plate upstream of the impurity removal unit 2, so a flow velocity of the feed gas can be increased, and a time of contact between the feed gas and the heating unit 4 can also be increased. As a result, the temperature of the feed gas can be increased by improving the heating efficiency, and the level of purity of the purified gas can be increased. The baffle plate is arranged between the supply unit 6 and the impurity removal unit 2, for example.

In this embodiment, the feed gas supplied from the supply unit 6 passes through the packing material 21 which is heated by means of the heating unit 4 and the outside heating unit 5, and impurities are removed from the feed gas, which is then discharged from the discharge unit 7 as a purified gas. The gas inside the purification vessel 3 flows in the first axial direction D11 (in one direction).

### Second Embodiment

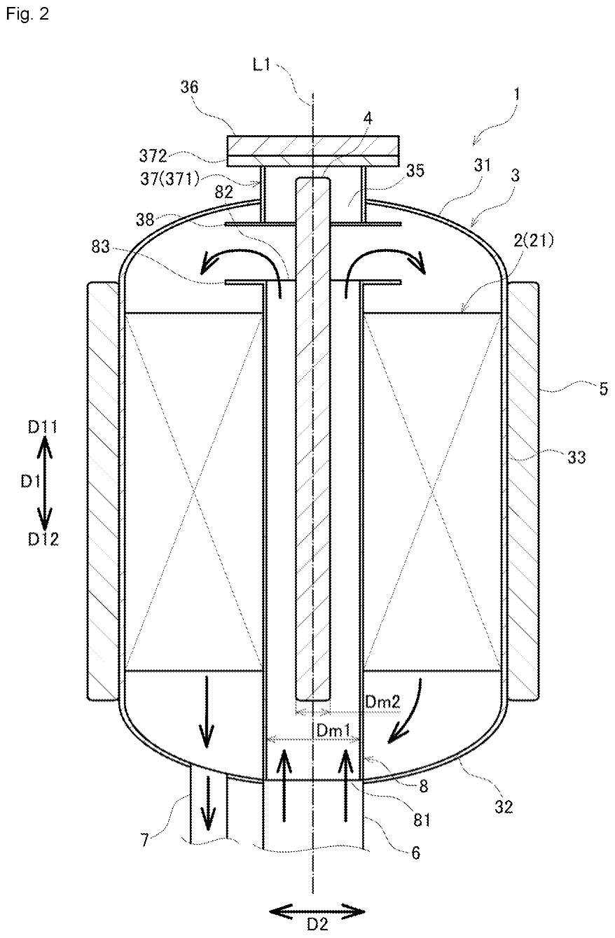

A second embodiment of the gas purification apparatus 1 according to the present disclosure will be described next with reference to FIG. 2. The gas purification apparatus 1 according to the second embodiment may be constructed in the same way as the gas purification apparatus 1 according to the first embodiment, except for the features described below, so the description will focus mainly on the differences while omitting the common features. FIG. 2 is a view in cross section showing the gas purification apparatus 1 according to the second embodiment.

As shown in FIG. 2, the purification vessel 3 comprises: an opening portion 35, and a lid portion 36 for restricting gas leakage from the opening portion 35. In this embodiment, the opening portion 35 is provided at the first end portion 31, and the lid portion 36 is attached to a cylinder portion 37 provided at the opening portion 35, but this is not limiting. For example, the opening portion 35 may be provided at the second end portion 32, and the lid portion 36 may be attached to the opening portion 35. In this embodiment, the purification vessel 3 does not comprise the inner cylinder portion 34 (see FIG. 1) of the first embodiment.

The cylinder portion 37 comprises: a cylinder portion main body 371 formed in a cylindrical shape; and a first flange portion 372 provided at an end portion of the cylinder portion main body 371 in the first axial direction D11. An outer diameter of the first flange portion 372 is greater than an outer diameter of the cylinder portion main body 371. The lid portion 36 is attached (e.g., bolted) to the first flange portion 372.

The purification vessel 3 comprises a holder 38 for holding the heating portion 4. The holder 38 is formed with a toric shape. An outer diameter of the holder 38 is greater than the outer diameter of the cylinder portion main body 371. In this embodiment, the holder 38 is bonded to an end portion (lower end portion) of the cylinder portion main body 371 in the second axial direction D12, but this is not limiting.

The heating unit 4 is detachably mounted in the holder 38. The heating unit 4 preferably projects from the holder 38 in the first axial direction D11 in a state in which the heating unit 4 is held by the holder 38. This makes it easier to remove the heating unit 4 from the holder 38. In this embodiment, the centre axis of the heating unit 4 is arranged so as to be substantially aligned with the centre axis L1 of the purification vessel 3, but this is not limiting.

The gas purification apparatus 1 comprises an internal pipe 8 provided (accommodated) inside the purification vessel 3 The internal pipe 8 is connected to the supply unit 6 at one end 81, while another end 82 thereof opens on the inside of the purification vessel 3. In this embodiment, the internal pipe 8 is a straight pipe, and the centre axis of the internal pipe 8 is substantially aligned with the centre axis L1 of the purification vessel 3 (centre axis of the heating unit 4), but this is not limiting.

Said other end 82 of the internal pipe 8 is provided between the impurity removal unit 2 and the holder 38. That is to say, said other end 82 of the internal pipe 8 is provided further in the first axial direction D11 than the impurity removal unit 2. A second flange portion 83 is provided at said other end 82 of the internal pipe 8. An outer diameter of the second flange portion 83 is substantially the same as the outer diameter of the holder 38. The second flange portion 83 is provided at a position away from the impurity removal unit 2 in the axial direction D1.

The impurity removal unit 2 is mounted in the purification vessel 3 and/or in the internal pipe 8. The heating unit 4 is inserted through the internal pipe 8 from the other end 82 of the internal pipe 8. Contact between the heating unit 4 and the packing material 21 during attachment/detachment is prevented by providing the internal pipe 8. In this embodiment, the heating unit 4 is provided inside the purification vessel 3.

The heating unit 4 is arranged in the internal pipe 8 at a predetermined interval therefrom. That is to say, an inner diameter Dm1 of the internal pipe 8 is greater than an outer diameter Dm2 of the heating unit 4. This makes it possible to provide a gap between the internal pipe 8 and the heating unit 4, allowing the feed gas to flow. Moreover, the gas purification apparatus 1 may comprise a support for supporting the heating unit 4, for example. In this case, the support is provided within the piping of the internal pipe 8. The support is preferably provided on an end portion side of the heating unit 4 in the second axial direction D12.

The supply unit 6 and the discharge unit 7 are arranged at one end (first end portion 31 or second end portion 32) of the purification vessel 3. The supply unit 6 and the discharge unit 7 are preferably arranged on the end portion of the purification vessel 3 located on the opposite side to the holder 38 in the axial direction D1. In this embodiment, the supply unit 6 and the discharge unit 7 are arranged on the second end portion 32 of the purification vessel 3, but are not limited to this arrangement. The supply unit 6 is arranged in the centre of the purification vessel 3 in the radial direction D2, and the discharge unit 7 is arranged further outward than the supply unit 6 in the radial direction D2, but this is not limiting.

The baffle plate is attached to the inside or the outside of the heating unit 4, and is inserted into the internal pipe 8 together with the heating unit 4, for example. The baffle plate is configured to be removable.

In this embodiment, the feed gas supplied from the supply unit 6 is heated by the heating unit 4 in the internal pipe 8, after which the feed gas flows to the packing material 21 from between the holder 38 and the second flange portion 83. The feed gas then passes through the packing material 21 and impurities are removed from the feed gas, which is then discharged from the discharge unit 7 as a purified gas. The packing material 21 is heated by means of the outside heating unit 5 and the feed gas, for example. The gas inside the purification vessel 3 flows in the first axial direction D11 (in one direction), and then flows in the second axial direction D12 (in the other direction). That is to say, the gas inside the purification vessel 3 flows one way and then returns along the axial direction D1.

### Third Embodiment

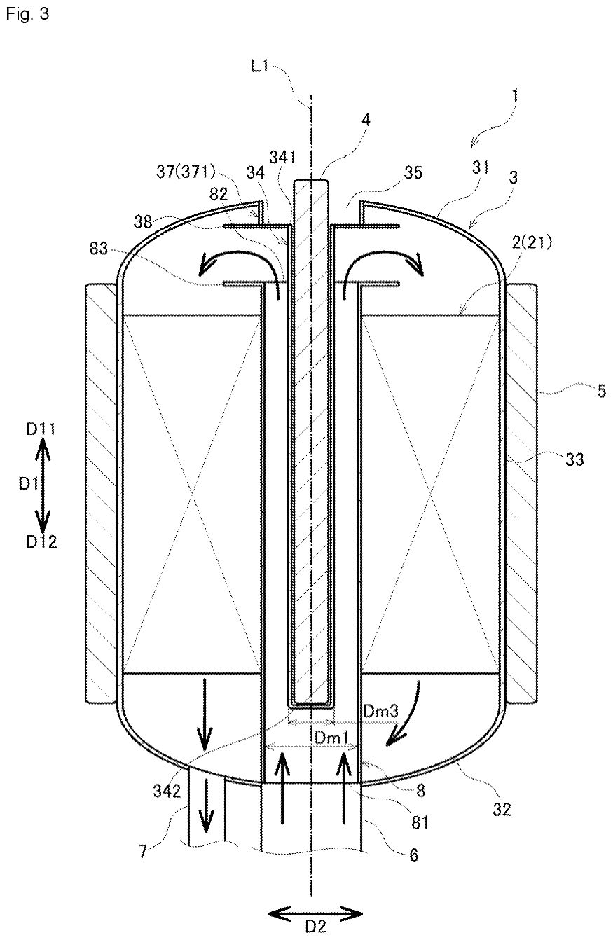

A third embodiment of the gas purification apparatus 1 according to the present disclosure will be described next with reference to FIG. 3. The gas purification apparatus 1 according to the third embodiment may be constructed in the same way as the gas purification apparatus 1 according to the second embodiment, except for the features described below, so the description will focus mainly on the differences while omitting the common features. FIG. 3 is a view in cross section showing the gas purification apparatus 1 according to the third embodiment.

The purification vessel 3 comprises the inner cylinder portion 34 detachably accommodating the heating unit 4 arranged in the internal pipe 8. The inner cylinder portion 34 is arranged inside the piping of the internal pipe 8. The centre axis of the inner cylinder portion 34 is substantially aligned with the centre axis L1 of the purification vessel 3. The inner diameter Dm1 of the internal pipe 8 is greater than an outer diameter Dm3 of the inner cylinder portion 34. In this embodiment, the inner cylinder portion 34 is formed with a cylindrical shape and is bonded to the holder 38, but this is not limiting.

In this embodiment, the purification vessel 3 does not comprise the lid portion 36, and the cylinder portion 37 does not comprise the first flange portion 372, but this is not limiting. The gas purification apparatus 1 may comprise a cover for covering the part of the heating unit 4 protruding from the inner cylinder portion 34. The gas flow inside the purification vessel 3 is the same as in the second embodiment.

### Fourth Embodiment

A fourth embodiment of the gas purification apparatus 1 according to the present disclosure will be described next with reference to FIG. 4. The gas purification apparatus 1 according to the fourth embodiment may be constructed in the same way as the gas purification apparatus 1 according to the third embodiment, except for the features described below, so the description will focus mainly on the differences while omitting the common features.

FIG. 4 is a view in cross section showing the gas purification apparatus 1 according to the fourth embodiment.

As shown in FIG. 4, the gas purification apparatus 1 comprises an in-pipe impurity removal unit 9 covering the periphery of the heating unit 4 inserted through the internal pipe 8. The in-pipe impurity removal unit 9 removes impurities in the feed gas in the internal pipe 8. The in-pipe impurity removal unit 9 is arranged between the inner cylinder portion 34 and the internal pipe 8. The in-pipe impurity removal unit 9 is formed in an annular shape, and the inner cylinder portion 34 is inserted through the inside of the in-pipe impurity removal unit 9. The in-pipe impurity removal unit 9 is attached to the internal pipe 8 and/or to the inner cylinder portion 34. In this embodiment, the in-pipe impurity removal unit 9 is formed with a toric shape, but is not limited to such a shape.

The end portion of the inner cylinder portion 34 (heating unit 4) in the second axial direction D12 is arranged further to the second axial direction D12 side than an end portion of the in-pipe impurity removal unit 9 in the second axial direction D12. A length of the in-pipe impurity removal unit 9 along the axial direction D1 is substantially the same as a length of the impurity removal unit 2 along the axial direction D1. The end portions of the in-pipe impurity removal unit 9 in the axial direction D1 are arranged at substantially the same positions as the end portions of the impurity removal unit 2 in the axial direction D1.

The in-pipe impurity removal unit 9 comprises an in-pipe packing material 91 including at least one of a catalyst, a getter material and an adsorbent. The in-pipe packing material 91 may be substantially the same as or different from the packing material 21. The gas purification apparatus 1 may further comprise a heating unit for heating the feed gas flowing through the supply unit 6.

In this embodiment, the feed gas supplied from the supply unit 6 passes through the in-pipe packing material 91 and impurities are removed therefrom, after which the feed gas passes through the packing material 21 and impurities are further removed therefrom, and the feed gas is discharged from the discharge unit 7 as a purified gas. The in-pipe packing material 91 is heated by means of the heating unit 4, for example. The packing material 21 is heated by means of the outside heating unit 5 and the gas that has passed through the in-pipe packing material 91, for example. The gas flow inside the purification vessel 3 is the same as in the second embodiment.

(1) As described above, the gas purification apparatus 1 according to the present disclosure comprises: the impurity removal unit 2 for removing impurities in the feed gas; the purification vessel 3 accommodating the impurity removal unit 2; and the heating unit 4 which is provided inside the purification vessel 3 in a state of non-contact with the impurity removal unit 2, and heats the purification vessel 3 from the inside, the heating unit 4 being detachably mounted in the purification vessel 3. By virtue of this configuration, the heating unit 4 provided inside the purification vessel 3 can be easily removed from the purification vessel 3, and the heating unit 4 can be easily mounted in the purification vessel 3. This enables simple repair or replacement of the heating unit 4 provided inside the purification vessel 3.

(2) The gas purification apparatus 1 according to embodiment (1) above preferably has a configuration in which the purification vessel 3 is arranged so that the impurity removal unit 2 surrounds the periphery thereof, and the purification vessel 3 comprises the inner cylinder portion 34 detachably accommodating the heating unit 4.

By virtue of this configuration, the heating unit 4 can be easily attached to/detached from the inner cylinder portion 34 (purification vessel 3) by insertion/withdrawal of the heating unit 4. Furthermore, the heating unit 4 can be prevented from coming into contact with the impurity removal unit 2 during attachment/detachment of the heating unit 4.

(3) The gas purification apparatus 1 according to embodiment (1) above preferably has a configuration comprising the baffle plate arranged on the inside of the purification vessel 3 upstream of the impurity removal unit 2.

By virtue of this configuration, the feed gas flow path can be controlled by means of the baffle plate upstream of the impurity removal unit 2, so the flow velocity of the feed gas can be increased, and the time of contact between the feed gas and the heating unit 4 can also be increased. By this means, the temperature of the feed gas can be increased by improving the heating efficiency, and the level of purity of the purified gas can be increased.

(4) The gas purification apparatus 1 according to any one of embodiments (1)-(3) above preferably has a configuration comprising: the supply unit 6 for supplying the feed gas to the purification vessel 3; and the discharge unit 7 for discharging, from the purification vessel 3, a purified gas that has passed through the impurity removal unit 2, the supply unit 6 and the discharge unit 7 being arranged at one end of the purification vessel 3.

By virtue of this configuration, a connection point between the gas purification apparatus 1 and piping of the supply unit 6, and a connection point between the gas purification apparatus 1 and piping of the discharge unit 7 can be provided on the same plane. This facilitates design and construction of the piping, and also simplifies the piping configuration of the gas purification apparatus 1 and the supply unit 6 and discharge unit 7.

(5) The gas purification apparatus 1 according to embodiment (1), (3) or (4) above preferably has a configuration comprising: the supply unit 6 for supplying the feed gas to the purification vessel 3; and the internal pipe 8 which is connected to the supply unit 6 at one end 81 and opens on the inside of the purification vessel 3 at the other end 82, the heating unit 4 being arranged in the internal pipe 8 at a predetermined interval therefrom.

By virtue of this configuration, the feed gas flowing through the internal pipe 8 can be heated by the heating unit 4. This makes it possible for the impurity removal unit 2 (packing material 21) to be heated when the heated feed gas passes through, and the impurity removal unit 2 (packing material 21) can be heated more efficiently. As a result, the purity of the purified gas can be increased, for example. Furthermore, the heating unit 4 can be prevented from coming into contact with the impurity removal unit 2 during attachment/detachment of the heating unit 4.

(6) The gas purification apparatus 1 according to embodiment (5) above preferably has a configuration in which the purification vessel 3 comprises the inner cylinder portion 34 detachably accommodating the heating unit 4 arranged in the internal pipe 8.

By virtue of this configuration, the heating unit 4 can be easily attached to/detached from the inner cylinder portion 34 (purification vessel 3) by insertion/withdrawal of the heating unit 4.

(7) The gas purification apparatus 1 according to embodiment (6) above preferably has a configuration in which the in-pipe impurity removal unit 9, which covers the periphery of the heating unit 4 inserted through the internal pipe 8 and removes the impurities in the feed gas, is provided between the inner cylinder portion 34 and the internal pipe 8.

By virtue of this configuration, the impurities are removed from the feed gas as a result of the feed gas passing through the in-pipe impurity removal unit 9, and impurities are further removed as a result of the gas that has passed through the in-pipe impurity removal unit 9 passing through the impurity removal unit 2. That is to say, a rate of contact between the impurities and the packing materials 21, 91 is increased by increasing the distance over which the feed gas passes through the impurity removal units 2, 9. This makes it possible to increase the purity of the purified gas.

(8) The gas purification apparatus 1 according to any one of embodiments (1)-(7) above preferably has a configuration comprising at least one of: the outside heating unit 5 for heating the purification vessel 3 from the outside; and the heat insulating portion for suppressing heat escape from the purification vessel 3, the outside heating unit 5 and/or the heat insulating portion being arranged so as to cover the periphery of the purification vessel 3.

By virtue of this configuration, it is possible to suppress a reduction in the temperature inside the purification vessel 3 due to external air, i.e., heat can be retained in the purification vessel 3. The impurity removal unit 2 (packing material 21) accommodated in the purification vessel 3 can be heated more efficiently when the outside heating unit 5 is provided.

It should be noted that the gas purification apparatus 1 is not limited to the configurations in the embodiments described above, and the effects thereof are not limited to those described above either. Furthermore, various modifications may of course be added to the gas purification apparatus 1 within a scope that does not depart from the gist of the present invention. For example, the configurations, etc. of the multiple embodiments described above may of course be adopted in any combination, and any one or more of the configurations, etc. relating to the variant examples described below may of course be freely selected for use in the configurations, etc. relating to the embodiments above.

(A) The second embodiment described above has a configuration in which the other end 82 of the internal pipe 8 opens on the inside of the purification vessel 3, but this is not limiting. For example, the internal pipe 8 may have a configuration comprising a plurality of through-holes or slits between the impurity removal unit 2 and the holder 38, with the other end 82 of the internal pipe 8 being connected to the holder 38. In this configuration, the feed gas flows out from the plurality of through-holes or slits.

(B) In the second embodiment described above, the internal pipe 8 is a straight pipe, but this is not limiting. The internal pipe 8 may be a T-shaped pipe, for example. In this configuration, a through-hole for insertion of the heating unit 4 is provided in the end portion (upper end portion) in the first axial direction D11 of the internal pipe 8, and that end portion serves as the holder 38 for the heating unit 4. Furthermore, the internal pipe 8 may be a cross pipe, for example. In this configuration, the first axial direction D11 side (upper side) of the internal pipe 8 serves as the cylinder portion 37.

### KEY TO SYMBOLS

1 . . . Gas purification apparatus, 2 . . . Impurity removal unit, 21 . . . Packing material, 3 . . . Purification vessel, 31 . . . First end portion, 32 . . . Second end portion, 33 . . . Side portion, 34 . . . Inner cylinder portion, 35 . . . Opening portion, 36 . . . Lid portion, 37 . . . Cylinder portion, 371 . . . Cylinder portion main body, 372 . . . First flange portion, 38 . . . Holder, 4 . . . Heating unit, 5 . . . Outside heating unit, 6 . . . Supply unit, 7 . . . Discharge unit, 8 . . . Internal pipe, 83 . . . Second flange portion, 9 . . . In-pipe impurity removal unit, 91 . . . In-pipe packing material, L1 . . . Centre axis

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A gas purification apparatus comprising:
an impurity removal unit for removing impurities in a feed gas;
a purification vessel accommodating the impurity removal unit; and
a heating unit which is provided inside the purification vessel in a state of non-contact with the impurity removal unit, and heats the purification vessel from the inside,
wherein the heating unit is detachably mounted in the purification vessel.

2. The gas purification apparatus according to claim 1, wherein the purification vessel is arranged so that the impurity removal unit surrounds a periphery thereof, the purification vessel comprising an inner cylinder portion detachably accommodating the heating unit.

3. The gas purification apparatus according to claim 1, further comprising a baffle plate which is arranged on the inside of the purification vessel upstream of the impurity removal unit.

4. The gas purification apparatus according to claim 1, further comprising:
a supply unit for supplying the feed gas to the purification vessel; and
a discharge unit for discharging, from the purification vessel, a purified gas that has passed through the impurity removal unit,
wherein the supply unit and the discharge unit are arranged at one end of the purification vessel.

5. The gas purification apparatus according to claim 1, further comprising:
a supply unit for supplying the feed gas to the purification vessel; and
an internal pipe which is connected to the supply unit at one end and opens on the inside of the purification vessel at another end,
wherein the heating unit is arranged in the internal pipe at a predetermined interval therefrom.

6. The gas purification apparatus according to claim 5, wherein the purification vessel comprises an inner cylinder portion detachably accommodating the heating unit arranged in the internal pipe.

7. The gas purification apparatus according to claim 6, wherein an in-pipe impurity removal unit for removing impurities in the feed gas is provided between the inner cylinder portion and the internal pipe.

8. The gas purification apparatus according to claim 1, further comprising at least one of:
an outside heating unit for heating the purification vessel from the outside, and
a heat insulating portion for suppressing heat escape from the purification vessel,
wherein the outside heating unit and/or the heat insulating portion are/is arranged so as to cover the periphery of the purification vessel.
